(19) United States
(12) Patent Application Publication
(10) Pub. No.: US 2019/0332574 A1
(43) Pub. Date: Oct. 31, 2019

(54) METHOD AND SYSTEM OF SNAPSHOT GENERATION AND MANAGEMENT

(71) Applicant: ASHISH PURI, PUNE (IN)

(72) Inventor: ASHISH PURI, PUNE (IN)

(21) Appl. No.: 15/965,979

(22) Filed: Apr. 30, 2018

(51) Int. Cl. G06F 16/11; G06F 16/901

(52) U.S. Cl. CPC G06F 16/128; G06F 16/9027

(57) ABSTRACT

In one aspect, a computerized method, useful for providing and managing scalable snapshots of a storage entity that avoids reference counts that leads to amplification issues, includes the steps of providing a base image generating a scalable snapshot of the base image; and setting an incremental layer identifier for the scalable snapshot.

### FIELD OF THE INVENTION

This application relates generally to snapshot generation and management.

### DESCRIPTION OF THE RELATED ART

The existing snapshotting technologies like reference counting and chaining have drawbacks. The reference counting leads to the write amplification issue. With chaining of snapshots, the IO performance becomes inversely proportional to the number of snapshots in the chain. In the layer identifier approach, the IO performance does not depend on the length of chain, neither it suffers from the write amplification issues.

### SUMMARY

In one aspect, a computerized method, useful for providing and managing scalable snapshots of a storage entity that avoids reference counts that leads to amplification issues, includes the steps of providing a base image generating a scalable snapshot of the base image; and setting an incremental layer identifier for the scalable snapshot.

Optionally, the computerized method can include the step of generating a chain of scalable snapshots. Each layer of the chain of scalable snapshots comprises a layer incremental layer identifier correlating to each respective layer. The computerized method can include the step of providing a reference of a set of metadata for the base image; representing the set of metadata as a tree data structure; and within the tree data structure; representing the scalable snapshots with the incremental layer identifier. Each time a chain of scalable snapshots is created, a set of new scalable snapshots can be assigned a new incremental layer identifier.

### BRIEF DESCRIPTION OF THE DRAWINGS

FIG. 1 illustrates an example process for providing and managing scalable snapshots of a storage entity according to some embodiments.

FIG. 2 depicts an example representation of a chain of scalable snapshots, according to some embodiments.

FIG. 3 illustrates an example metadata tree, according to some embodiments.

FIG. 4 illustrates an example process of decoupling metadata from data in a key-value database, according to some embodiments.

FIG. 5 illustrates an example process of an image repository, according to some embodiments.

FIG. 6 depicts an exemplary computing system that can be configured to perform any one of the processes provided herein.

The Figures described above are a representative set, and are not an exhaustive with respect to embodying the invention.

### DESCRIPTION

Disclosed are a system, method, and article of manufacture for method and system of snapshot generation and management. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Base image is some dataset which can be used as base to create another (base) image by adding/removing/modifying some data.

Block can be units used to store electronic data.

B-tree can be a self-balancing tree data structure that keeps data sorted and allows searches, sequential access, insertions, and deletions in logarithmic time. The B-tree can be a generalization of a binary search tree in that a node can have more than two children.

Container can be a server virtualization instance used in operating system-level virtualization.

DOCKER is an open-source project that automates the deployment of applications inside software containers, by providing an additional layer of abstraction and automation of operating-system-level virtualization on LINUX. DOCKER uses the resource isolation features of the LINUX kernel such as cgroups and kernel namespaces, and a union-capable file system such as aufs and others to allow independent “containers” to run within a single LINUX instance, avoiding the overhead of starting and maintaining virtual machines.

Key-value database can be a data storage paradigm designed for storing, retrieving, and managing associative arrays (e.g. a dictionary or hash). Dictionaries may contain a collection of objects, or records, which in turn have many different fields within them, each containing data. These records are stored and retrieved using a key that uniquely identifies the record, and is used to quickly find the data within the database.

Image can be the state of a computer system stored in some form.

Pointer can be an object whose value refers to another value stored elsewhere in the computer memory using its address.

Read operation can be used to retrieve data from a storage device/entity.

Root node can be the node in a tree data structure from which every other node is accessible.

Snapshot a set of computer files and directories kept in storage as they were sometime in the past. Each iteration of a snapshots can be a clone.

Tree can be an abstract data type (ADT) or data structure implementing a ADT. The tree structure can simulate a hierarchical tree structure, with a root value and subtrees of children with a parent node, represented as a set of linked nodes.

Virtual machine (VM) can be an emulation of a particular computer system. VMs operate based on the computer architecture and functions of a real or hypothetical computer, and their implementations may involve specialized hardware, software, or a combination of both.

Virtual disk can be set of software components that emulate an actual disk storage device.

Write operation can be creating or altering digital data in a storage device/entity.

### Example Methods

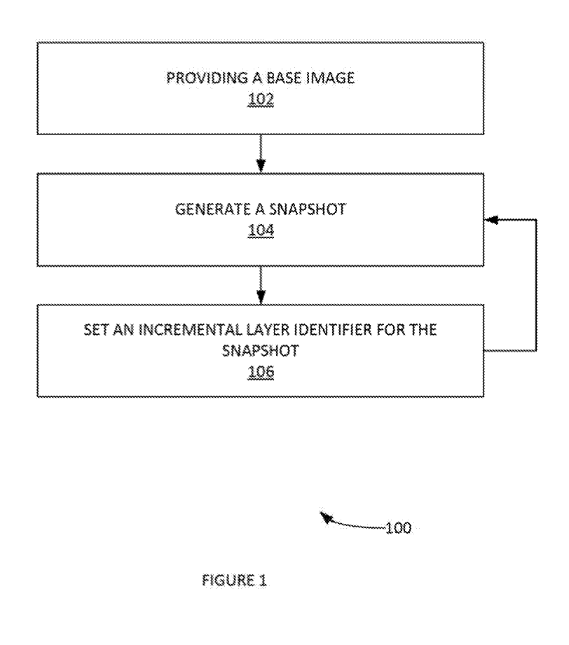

FIG. 1 illustrates an example process 100 for providing and managing scalable snapshots of a storage entity (e.g. a virtual or physical disk) according to some embodiments. The method can be used to generate and manage a chain of scalable snapshots. The method can avoid reference counts that may lead to write amplification issues and snapshot chaining which may limit the snapshot depth due to degraded performance.

In one example, the references of the metadata can be provided. The metadata can be represented in a tree form (e.g. as a B-tree, etc.). A snapshot copy of a root node (e.g. a portion of the storage entity, etc.) can be created. In the tree, scalable snapshots can be represented with a layer identifier. The layer identifier can be an incremental number. Each time a chain of scalable snapshots is created, the new snapshots can be assigned a layer identifier. A In this context, creating snapshot does not degrade the IO performance. Hence, a very large number of snapshots can be created. This is unlike the snapshot technology which employs chaining to link the snapshots.

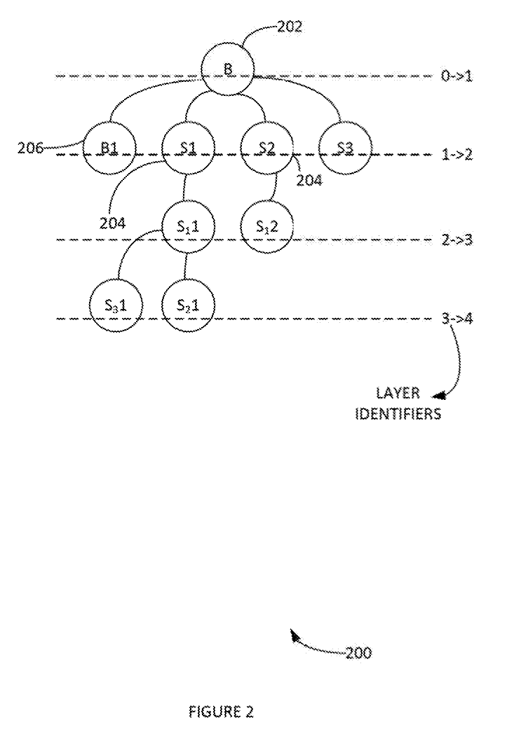

More specifically, in step 102 a base image can be provided. A base image (e.g. a DOCKER base image) can a basic image on which addition layers (e.g. filesystem changes) are added and a final image containing an application can be created. In step 104, a snapshot can be generated. The snapshot can be of the base image or another previously generated snapshot. In step 106, an incremental level can be set for the snapshot. FIG. 2 infra provides an example representation of a tree 200 generated by process 100.

FIG. 2 depicts an example representation of a tree 200 of scalable snapshots, according to some embodiments. Tree 200 can provide how a set of scalable snapshots are related to each other. Tree 200 can include a base image. For example, the base image can include one-hundred gigabytes of data (or another specified amount of data). Read operations and/or write operations can be performed on the base image. At a specified point in time, a snapshot S1 (e.g. a clone) can be taken of the base image. Snapshot S1 can be a read/write snapshot that can accept both read operations and/or write operations. For example, snapshot S1 can be mounted (e.g. made accessible to read/write operations, etc.). After a write, snapshot S1 can include differences from the base image.

It is noted that multiple snapshots can be created from the base image. For example, snapshot S2 can be generated as a read/write snapshot of the base image at a specified time. Additional, ‘n’ number of snapshots (e.g. snapshot S3, etc.) can be created in this way). When a snapshot is created, the base image is ‘frozen’. This means that the base image is no longer writeable. The ‘frozen’ base image is read only. In order to write to the base image, a clone of the base image B′ can be generated. This base-image clone B′ can receive and implement write operations. Additionally, snapshots can be cloned into other snapshots to create various chains of snapshots as well. For example, a snapshot S₁1 can be made from snapshot S1. A snapshot S₂1 can be made from snapshot S₁1. A snapshot S₁2 can be made from snapshot S2. Tree 200 is provided by way of example and not of limitation. In other examples, other tree-structures can be generated with other chains of scalable snapshots.

The method of formation of tree 200 can be utilized to generate a representation of metadata related to the base image and snapshots of tree 200. Each level of the depth of the tree can be numbers. For example, the base image can be level 0->1. The layer of B′, S1 and S2 can be level 1->2 and so on as provided in FIG. 2. Tree depth levels can be used to represent the metadata of the snapshots for the various blocks. Each level can have a layer identifier.

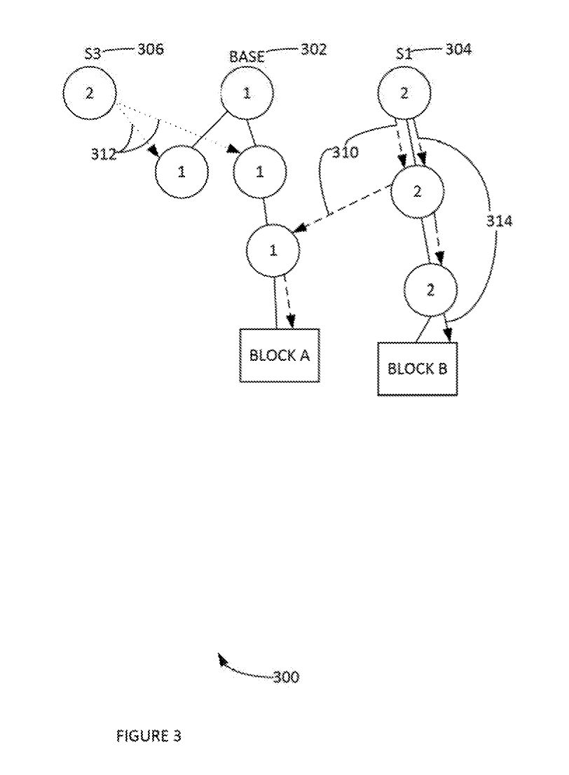

Metadata information about the base image and snapshots can also include information about the relevant layer identifiers. Accordingly, FIG. 3 illustrates an example metadata tree 300, according to some embodiments. Metadata tree 300 can be a B-plus tree in some embodiments. Metadata tree 300 can have entries to the blocks of the base image or various snapshots. Each node of metadata tree 300 can represent a block of metadata about tree 200. For example, the node can include the pointers to the address in the storage entity the relevant data for an operation is located. The metadata can also include snapshots, quality of service information, data management features, etc. The various paths of metadata tree 300 can be traversed to locate said data. Metadata tree 300 shows the layer identifiers of each node. The base 302 has nodes with layer identifier of ‘1’. Snapshots S1 304 and S3 306 have nodes with layer identifiers of ‘2’. With respect to tree 200 of FIG. 2, Snapshot S1 304 and its nodes represent the single node S1 in tree 200. Snapshot S3 306 and its nodes represent the single node S3 in tree 200. This pattern continues for base 302. The leaf nodes can represent data blocks. For example, a write operation 314 to S1 304 can use the metadata of its nodes to find block B. A read operation 312 to S1 can use the metadata pointers in its nodes to find the nodes of the base image's metadata pointers to find block A. S1 304 cannot be deleted in this way because there are divergent in between (see FIG. 2). For example, there is an S₁1, S₂1 etc. In the event of a deletion of S1 304, it would inform its parent nodes in tree 200 and merge its references/information downwards to its child node(s).

However, S3 306 forms a single chain of snapshots (e.g. no divergent snapshots) and can be deleted. S2 in FIG. 2 also forms a single chain of snapshots. In the case of a deletion of S3 306, its immediate parent and children can be determined and the entries of S3 306 can be merged downwards. Here, S3 306 has no child snapshot nodes. However, is S2 were deleted than its entries can be merged to S12.

When the base image creates metadata nodes that record operation histories (e.g. write operations, etc.), the associated metadata nodes can have a layer identifier of ‘1’. Continuing the present example, when S1 creates a root entry, its metadata nodes can have a layer identifier ‘2’. Each member of the tree 200 creates metadata nodes with the corresponding layer identifiers as provided in FIG. 2. The layer identifier also identifies the member of tree 200 that is responsible for destroying the associated metadata nodes. In one example, snapshot S2 also has the same layer identifier of ‘2’ with snapshot S1 (e.g. as shown in FIG. 2).

When a write operation to S1 is occurring, the metadata nodes with layer identifier ‘2’ can be traversed until the leaf node is determined. Any nodes traversed on the way to the leaf node that are not already labeled with layer identifier ‘2’ can be copied and relabeled with identifier layer ‘2’. For write operations, just the nodes that are traversed are modified and copied to the current layer identifier.

When there is a read operation, the various nodes of tree 300 can include pointers to the addressed block. For example, the dotted line shows a path to reach a leaf-node block of the base image that can be reached from snapshot S1 as the block was never modified by S1. Layer deletion operations within a block can be performed directly on the blocks with the same layer identifier. It is noted that snapshots within a chain (e.g. not at the end of the chain) cannot be deleted. In the present example of tree 300, S1 cannot be deleted but S2 can be deleted. This is because here there is a single chain of snapshots with no divergent snapshots from it. In the event S2 is deleted, its node's layer identifiers can be dropped down to layer identifier ‘3’ and its entries can be merged with the next dependent snapshot.

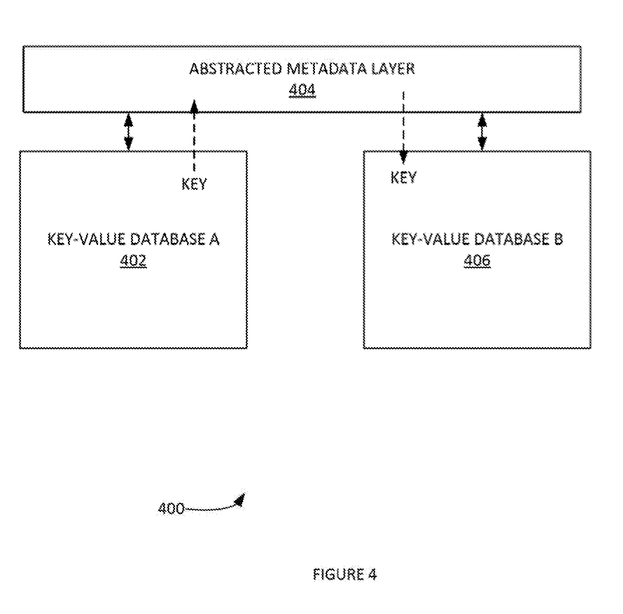

FIG. 4 illustrates an example process 400 of decoupling metadata from data in a key-value database, according to some embodiments. Process 400 can be used to transfer key-value paired data from one type of key-value database (e.g. CASSANDRA® database) to another type of key-value database (e.g. a CEPH® database). Process 400 can decouple the metadata and data in the data storage such that the data can be represented by any key-value pair.

A key-value database can be a database system that uses key-value pairs. For example, in a key-value database, the data can be represented by a key-value pair. This paradigm can be used to build the data-storage system. The data-storage system can be based on the key-value system may not have a hierarchy as with a ‘traditional’ filesystem. For example, given a value of an entity as its key, the key-value system can determine how the data is stored (e.g. how stored on an SSD, in a cloud-computing platform, etc.). The key-value pairs can have a set of constructs. For example, given a key then a particular value can be obtained. This can be used to implement various operations such as, inter alia: get operations, put operations, etc. In this way, a particular key-value database can be dependent on its own key-value pairs that may not be transferable to other types of key-value databases.

In one example, key-value database A 402 can be a Cassandra®-type database. The metadata of key-value database A 402 can be decoupled from its data. For example, the keys of key-value database A 402 can be queried and stored as metadata 404. The metadata 404 can be represented based on the structures and methods of trees 200 and 300 in FIGS. 2 and 3 supra. The data can be transferred to key-value database A 406. The keys for this data can be generated from metadata 404. For example, a snapshot (e.g. S2 from FIG. 2) can be in key-value database A 402. The keys for the snapshot can be abstracted to metadata layer 404. The snapshot can be transferred to key-value database B 406. A new set of keys compatible with key-value database B 406 can then be generated from metadata 404 and utilized. Process 400 need not copy all the keys of the snapshot, rather it can copy just the ones with the appropriate layer identifier associated with the snapshot and/or it can transfer keys that are for the layer identifier associated with the transferred snapshot.

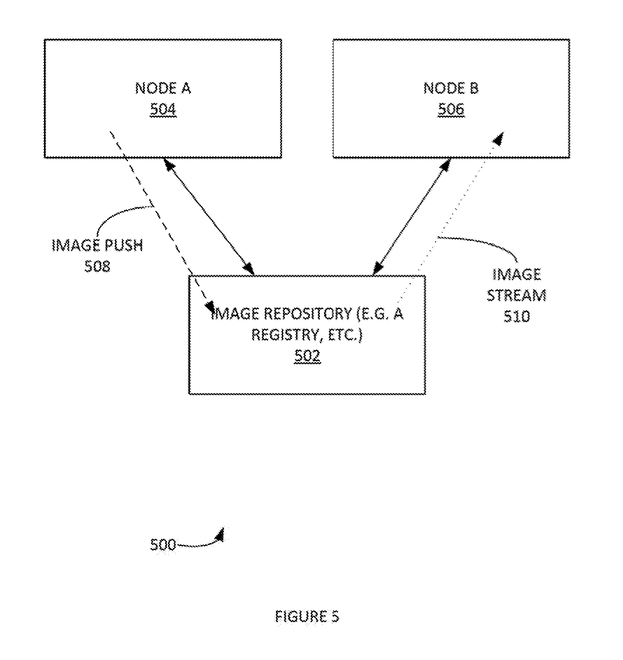

FIG. 5 illustrates an example process 500 of an image repository, according to some embodiments. Image repository 502 can store images (e.g. for containers, for a virtual machine, etc.). For example, a workflow for a DOCKER container can be provided. The present example is a workflow for a DOCKER container, however this example can be modified for other image management systems as well. In the present example, image repository 502 can include a registry. The registry can store images and maintain a hash table that associates the stored images with a data pointer. The data pointer can provide where the image is stored in the various areas of the storage system. When an image is built by node A 504, it is pushed to the central repository (e.g. with DOCKER push, etc.) in image push operation 508. An image can represent a container, a VM, an application, etc. When node B 506 seeks to access/use the image it can pull the image from the registry in a pull operation such as image stream 510. In pull operation 501, the registry can provide the data pointer associated with the image and node B 506 can use the data pointer to access the various areas of the storage system that store the image. The image can be streamed to node B 506 as the storage system can transfers image to node B 506. The image can be run in node B 506 during image stream operation 510.

Additional Computer Architecture

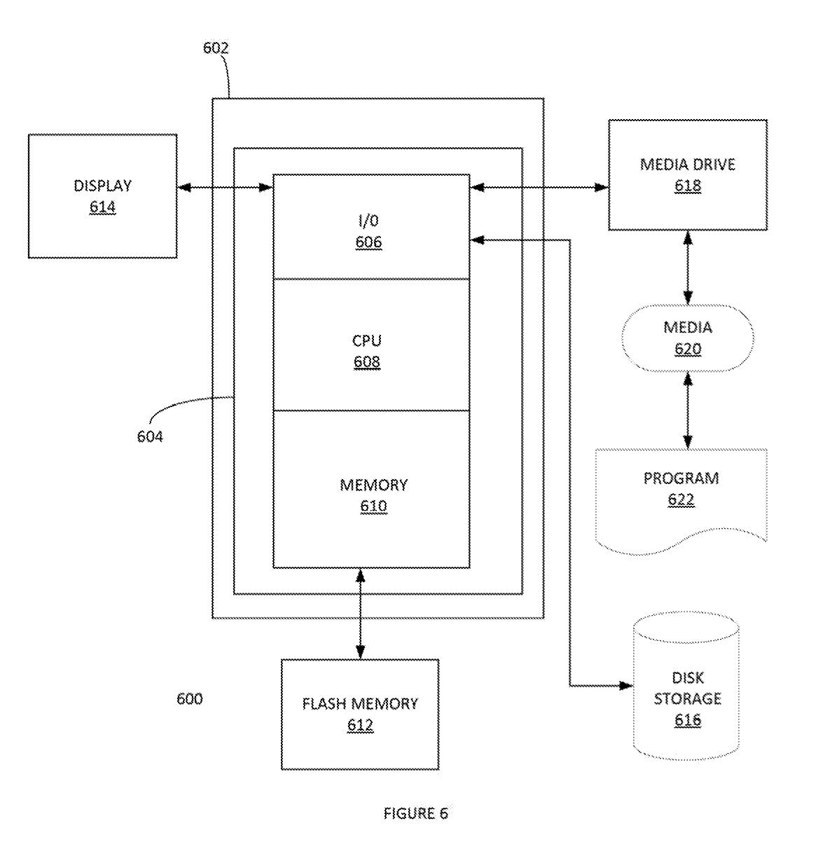

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. Computing system 600 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized method, useful for providing and managing scalable snapshots of a storage entity that avoids reference counts that leads to amplification issues, comprising:
providing a base image;
generating a scalable snapshot of the base image; and
setting an incremental layer identifier for the scalable snapshot.

2. The computerized method of claim 1 further comprising:
generating a chain of scalable snapshots, wherein each layer of the chain of scalable snapshots comprises a layer incremental layer identifier correlating to each respective layer.

3. The computerized method of claim 2 further comprising:
providing a reference of a set of metadata for the base image;
representing the set of metadata as a tree data structure; and
within the tree data structure:
representing the scalable snapshots with the incremental layer identifier, and wherein each time a chain of scalable snapshots is created, a set of new scalable snapshots is assigned a new incremental layer identifier.

4. The computerized method of claim 3, wherein the incremental layer identifier comprises an incremental number.

5. The computerized method of claim 4, wherein the tree data structure comprises a B-tree data structure.

6. The computerized method of claim 5 further comprising:
creating a snapshot copy of a root node, wherein the root node comprises a portion of the storage entity.

7. The computerized method of claim 5, wherein the storage entity comprises a virtual disk system.

8. The computerized method of claim 5, wherein the storage entity comprises physical disk system.

9. A computer system, useful for providing and managing scalable snapshots of a storage entity that avoids reference counts that leads to amplification issues, comprising:
at least one processor configured to execute instructions;
a memory containing instructions when executed on the processor, causes the at least one processor to perform operations that:
provide a base image;
generate a scalable snapshot of the base image; and
set an incremental layer identifier for the scalable snapshot.

10. The computerized system of claim 9, wherein the memory containing instructions when executed on the processor, causes the at least one processor to perform operations that:
generates a chain of scalable snapshots, wherein each layer of the chain of scalable snapshots comprises a layer incremental layer identifier correlating to each respective layer.

11. The computerized system of claim 10, wherein the memory containing instructions when executed on the processor, causes the at least one processor to perform operations that:
provides a reference of a set of metadata for the base image;
represents the set of metadata as a tree data structure; and
within the tree data structure:
represents the scalable snapshots with the incremental layer identifier, and wherein each time a chain of scalable snapshots is created, a set of new scalable snapshots is assigned a new incremental layer identifier.

12. The computerized system of claim 11, wherein the incremental layer identifier comprises an incremental number.

13. The computerized system of claim 12, wherein the tree data structure comprises a B-tree data structure.

14. The computerized system of claim 13, wherein the memory containing instructions when executed on the processor, causes the at least one processor to perform operations that:
creates a snapshot copy of a root node, wherein the root node comprises a portion of the storage entity.

15. The computerized system of claim 14, wherein the storage entity comprises a virtual disk system.

16. The computerized system of claim 15, wherein the storage entity comprises physical disk system.
